(19) United States
(12) Patent Application Publication
(10) Pub. No.: US 2006/0200441 A1
(43) Pub. Date: Sep. 7, 2006

(54) Information processing apparatus, information managing apparatus, information managing system, information processing method, information managing method, information processing program, information managing program, and recording medium

(76) Inventor: Tetsuro Nagatsuka, Kanagawa (JP)

Correspondence Address: COOPER & DUNHAM, LLP, 1185 AVENUE OF THE AMERICAS, NEW YORK, NY, 10036, US

(21) Appl. No.: 11/359,950

(22) Filed: Feb. 21, 2006

(30) Foreign Application Priority Data
Feb. 21, 2005 (JP) 2005-044529
Sep. 15, 2005 (JP) 2005-269159

(51) Int. Cl. G06F 17/30; G06F 15/16

(52) U.S. Cl. 707/1; 715/968; 709/203

(57) ABSTRACT

An information processing apparatus is capable of performing an application for allowing a user to operate a document using GUI. The information processing apparatus has an information obtaining unit configured to detect a predetermined event concerning the GUI and to obtain document information about a document to be operated in an active application upon detecting the predetermined event.

### BACKGROUND OF THE INVENTION

1. Field of the Invention

The present invention relates to an information processing apparatus, an information managing apparatus, an information managing system, an information processing method, an information managing method, an information processing program, an information managing program, and a recording medium. In particular, the present invention relates to an information processing apparatus, an information processing method, an information managing apparatus, an information managing system, an information processing method, an information managing method, an information processing program, an information managing program, and a recording medium, in which information about a document to be operated is processed or managed using an application.

2. Description of the Related Art

In recent years, floods of information due to the spread of the Internet, computerized offices, and the like have posed many problems, so that a technique for efficiently utilizing valuable and necessary information from a large amount of information has been required. One of the proposed techniques enables a user to register and use evaluation of information. Main objects of these techniques can be referred to as personal information management and information sharing/recommendation among a plurality of users.

The personal information management includes a technique for recording and managing user's personal browsing history and evaluation of browsed documents and information so as to facilitate later search/reference of valuable documents and information.

The information sharing among a plurality of users includes a technique for sharing evaluation information about documents and information among a plurality of users, by which searching/browsing of valuable documents and information is performed using other users' evaluation information.

For example, in a Web browser, a groupware application, and the like, personally browsed documents or information can be registered in a list referred to as a bookmark list. Thus, users are readily capable of displaying a relevant document upon browsing again just by selecting the document from the bookmark list.

However, bookmark information under the current conditions can be registered only in applications with a bookmark registration function. This poses a problem in that bookmark registration cannot be made regarding documents browsed using an application without such a function. It is also problematic in that the bookmark information is independently managed in each application, so that it is impossible to perform sharing or reference between different apparatuses, different applications, or among a plurality of users.

In view of these problems, recently, services have been provided by which bookmarks of documents (WWW documents) browsed with a Web browser can be stored and shared on a network. By using such services, bookmark information can be shared between different apparatuses or among a plurality of users.

However, these services are intended to be applied to WWW documents allowing only those documents that can be browsed with a Web browser to be registered. This poses a problem in that it is impossible to register groupware documents or DB documents using a dedicated client application, documents drafted using a word processor, documents of spreadsheet software, documents of presentation drafting software, and the like. Further, a registration operation must be performed using a Web browser in which a registration function is implemented. Or if the registration function is not implemented, it is necessary to access a WWW page for registration using a Web browser to perform registration. Thus, this is also problematic in that registration cannot be readily performed while browsing with other application.

Some Web pages have an embedded function therein, allowing users referring to the page to input evaluation. In such Web pages, evaluations of a plurality of users are counted and displayed, thereby enabling other users to judge whether information on the Web pages is useful or not.

However, in this case, the evaluation input function must be embedded in the subject Web pages and this poses a problem in that evaluation cannot be inputted for documents or information without such a function.

Patent Document 1 discloses a system of a knowledge database, by which it is possible to register evaluation of reference documents and to efficiently search desired documents using the evaluation information. The system is intended to enable conditional searching which more appropriately meets the needs of users by using the evaluation information of users.

However, documents to be evaluated in the system must be stored in a document DB of a server computer and this is problematic in that unregistered documents cannot be evaluated. Patent Document 1 also discloses the display and input of information performed using a Web browser. Thus, this also poses a problem in that registration, evaluation registration, browsing, or the like cannot be performed regarding documents and information that cannot be displayed using the Web browser. In addition, the system is problematic in that it is intended for sharing or recommendation of information among a plurality of users and thus cannot be used for personal information management.

Patent Document 2 discloses a system capable of allowing users to add personal marks and comments to online documents having HTML tags, XML tags, or the like, such that the users can share personal additional information with other users while maintaining personality by setting access limitation on the added marks and comments. The system is characterized in that the subjects of operation are tagged documents and that the personal additional information is superimposed on the original online documents and displayed. The system can be used for both objects of personal information management and information sharing among a plurality of users.

However, the subjects of operation are limited to structured documents having HTML tags, XML tags, or the like, and this is problematic in that other documents cannot be handled.

Patent Document 1: Japanese Laid-Open Patent Application No. 2004-86332

Patent Document 2: Japanese Laid-Open Patent Application No. 2001-22749

Major problems of the conventional techniques using evaluation of users regarding documents and information include the following two facts.

(1) Users today deal with diverse applications and documents in various forms in their daily lives and work. Under such conditions, when only a specific application and documents of a specific form are registered for evaluation or handled as the objects of use, only a part of users' information activity is supported. Thus, it is necessary to be able to register and use evaluation in any application and for documents in any form.

(2) Evaluation information about documents should be available for both objects of personal information management and information sharing among a plurality of users. If the evaluation information is used only for either of the objects, this is very inconvenient since users only obtain the effects of either of the objects or must use a plurality of systems or applications for each object.

### SUMMARY OF THE INVENTION

It is a general object of the present invention to provide an improved and useful information processing apparatus, information managing apparatus, information managing system, information processing method, information managing method, information processing program, information managing program, and recording medium in which the above-mentioned problems are eliminated.

A more specific object of the present invention is to provide an information processing apparatus capable of performing an application for allowing a user to operate a document using GUI by which it is possible to readily collect and manage information about a document browsed with a given application.

In order to solve the aforementioned problems, the present invention provides, according to one aspect of the present invention, an information processing apparatus capable of performing an application for allowing a user to operate a document using GUI. The information processing apparatus has an information obtaining unit configured to detect a predetermined event concerning the GUI and to obtain document information about a document to be operated in an active application upon detecting the predetermined event.

In such an information processing apparatus, it is possible to collect document information about a document to be operated by a given application.

The present invention provides, according to another aspect of the present invention, an information managing apparatus. The information managing apparatus has a receiving unit configured to receive the document information and document-related information from an information processing apparatus according to yet another aspect of the present invention. The information managing apparatus also has a memory unit configured to store the document information and the document-related information received by the receiving unit.

In such an information managing apparatus, it is possible to manage document information about a document to be operated by a given application and document-related information.

In order to solve the aforementioned problems, the present invention may provide an information processing method in the information processing apparatus, an information processing program for causing a computer to perform the information processing method, or a recording medium in which the information processing program is stored.

In order to solve the aforementioned problems, the present invention may provide an information managing method in the information managing apparatus, an information managing program for causing a computer to perform the information managing method, or a recording medium in which the information managing program is stored.

In order to solve the aforementioned problems, the present invention may provide an information managing system including the information processing apparatus and the information managing apparatus.

According to the present invention, it is possible to provide an information processing apparatus, information managing apparatus, information managing system, information processing method, information managing method, information processing program, information managing program, and recording medium by which it is possible to readily collect and manage information about a document browsed with a given application.

### BRIEF DESCRIPTION OF THE DRAWINGS

FIG. 1 is a diagram showing a configuration example of a document information managing system according to an embodiment of the present invention;

FIG. 2 is a diagram showing a configuration example of a user management DB;

FIG. 3 is a diagram showing a configuration example of hardware of a client computer according to an embodiment of the present invention;

FIG. 4 is a diagram showing a display example of a user information input dialog;

FIG. 5 is a flowchart describing a process for obtaining document information;

FIG. 6 is a diagram showing an example of a list of applications supporting automation;

FIG. 7 is a diagram showing an example of document information obtained by a processing portion for obtaining browsed document information;

FIG. 8 is a flowchart describing a process for inputting evaluation information;

FIG. 9 is a diagram showing a first example of an evaluation information input screen;

FIG. 10 is a diagram showing a second, example of an evaluation information input screen;

FIG. 11 is a diagram showing a configuration example of a document evaluation information managing DB;

FIG. 12 is a diagram showing a display example of an evaluation information displaying page; and

FIG. 13 is a flowchart describing a process for generating an evaluation information displaying page by a processing portion for generating display data of document evaluation information.

### DESCRIPTION OF THE PREFERRED EMBODIMENTS

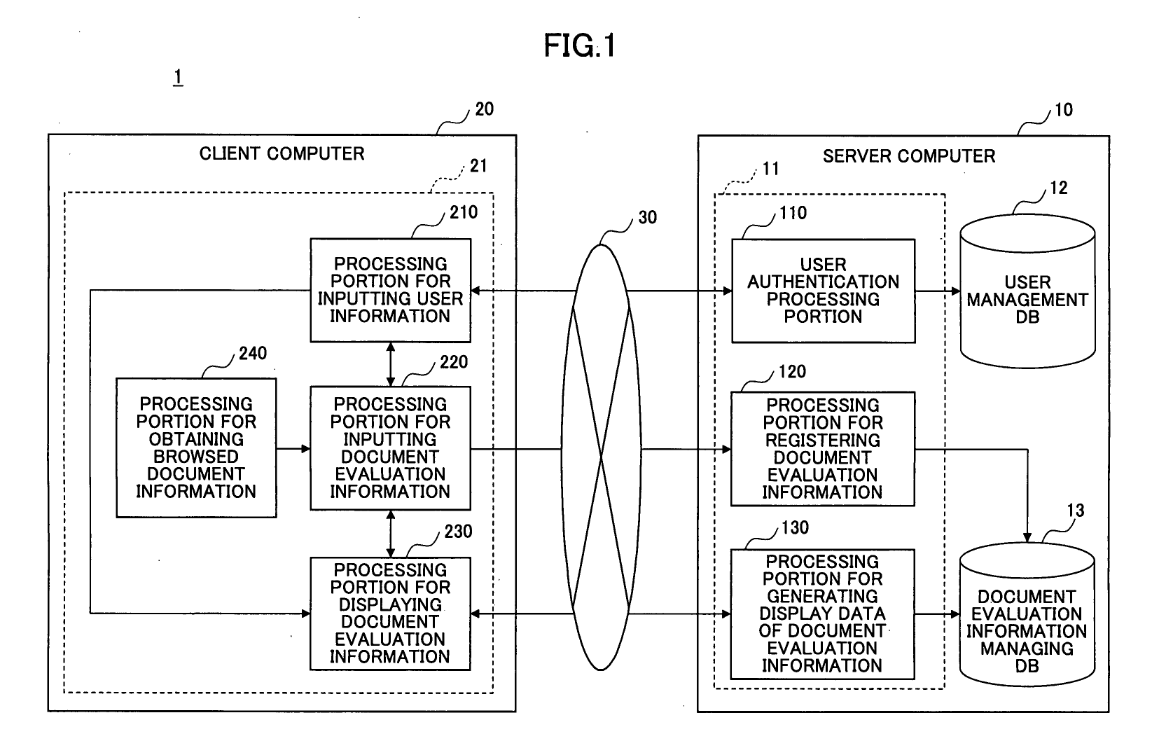

In the following, an embodiment of the present invention will be described with reference to the accompanying drawings. FIG. 1 is a diagram showing a configuration example of a document information managing system according to an embodiment of the present invention. In FIG. 1, a document information managing system 1 comprises a server computer 10 and a client computer 20 connected to each other via a LAN (Local Area Network) or a network (regardless of whether it is a wired network or a radio network) such as the Internet. The combination of the server computer 10 and the client computer 20 does not have to be constituted on a one-to-one basis but may be of various forms, such as a one-to-many, many-to-one, or many-to-many basis.

The client computer 20 includes a computer in which a client program 21 is implemented as a client function of the document information managing system 1. In this case, the client function is referred to as the generic functions the client program 21 provides. The client program 21 comprises the functions of a processing portion 210 for inputting user information, a processing portion 220 for inputting document evaluation information, a processing portion 230 for displaying document evaluation information, a processing portion 240 for obtaining browsed document information, and the like.

The processing portion 210 for inputting user information includes a function for allowing a user, in response to the activation of the client program 21, to input a user name and a password (hereafter referred to as user information) and for transmitting a request for authenticating the inputted user information to a user authentication processing portion 110 of the server computer 10.

The processing portion 240 for obtaining browsed document information includes a function for monitoring events concerning the GUI (Graphic User Interface) of various applications displayed on a display device of the client computer 20 and for obtaining, in response to the detection of a predetermined event, information about a document (hereafter referred to as document information) to be operated in a currently active application. Examples of the document information to be obtained include location information (location information of a document such as URL or a file path), a document title, information about the contents of a document (text information, for example), information about an application used for document browsing, a snapshot image of a document being browsed, a network address of the client computer 20, and the like.

The processing portion 220 for inputting document evaluation information includes a function for allowing the user to input evaluation information about a document being browsed and for transmitting the inputted evaluation information and document information, obtained by the processing portion 240 for obtaining browsed document information, to a processing portion 120 for registering document evaluation information of the server computer 10. Examples of the evaluation information include a user name, time of evaluation input, an evaluation score, a comment, a category, and the like.

The processing portion 230 for displaying document evaluation information comprises a transmitting unit and a receiving unit. The transmitting unit transmits a request for supplying document information and evaluation information registered in the server computer 10 to a processing portion 130 for generating display data of document evaluation information. The receiving unit receives the document information and the evaluation information, transmitted by the processing portion 130 for generating display data of document evaluation information, and displays display data thereof on the display device.

The server computer 10 includes a computer in which a server program 11, a user management DB (Data Base) 12, a document evaluation information managing DB (Data Base) 13, and the like are implemented as server functions of the document information managing system 1. In this case, the server functions are referred to as the generic functions the server program 11 provides.

The server program 11 includes a daemon program basically always activating in the server computer 10. The server program 11 comprises the user authentication processing portion 110, the processing portion 120 for registering document evaluation information, the processing portion 130 for generating display data of document evaluation information, and the like.

The user authentication processing portion 110 includes a function for performing user authentication by checking user information, transmitted by the processing portion 210 for inputting user information of the client computer 20, with user information registered in the user management DB 12 in advance.

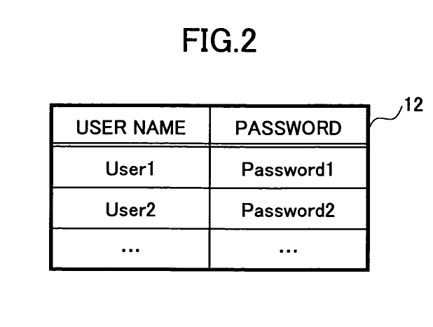

FIG. 2 is a diagram showing a configuration example of the user management DB. As shown in FIG. 2, in the user management DB 12, a user name and a password of each of users permitted to use the document information managing system 1 are registered in advance.

The processing portion 120 for registering document evaluation information includes a function for registering document information and evaluation information, transmitted by the processing portion 220 for inputting document evaluation information of the client computer 20, in the document evaluation information managing DB 13 used as a memory unit.

The processing portion 130 for generating display data of document evaluation information includes a function for searching the document evaluation information managing DB 13 for the document information and evaluation information in response to the request for supplying document information and evaluation information from the processing portion 230 for displaying document evaluation information of the client computer 20. In addition, the function also generates display data (Web pages, for example) of the retrieved document information and evaluation information and transmits the generated display data to the processing portion 230 for displaying document evaluation information.

In the present embodiment, although the system is configured to separately include the server apparatus and the client apparatus, the server apparatus may have the function of the client apparatus or the system may be configured to comprise a plurality of information processing apparatuses having both functions of the server apparatus and the client apparatus. In the case of the plurality of information processing apparatuses having both functions of the server apparatus and the client apparatus, it is necessary to have a process such that it refers to a database portion of other apparatus or unifies the contents of the database portion in each apparatus.

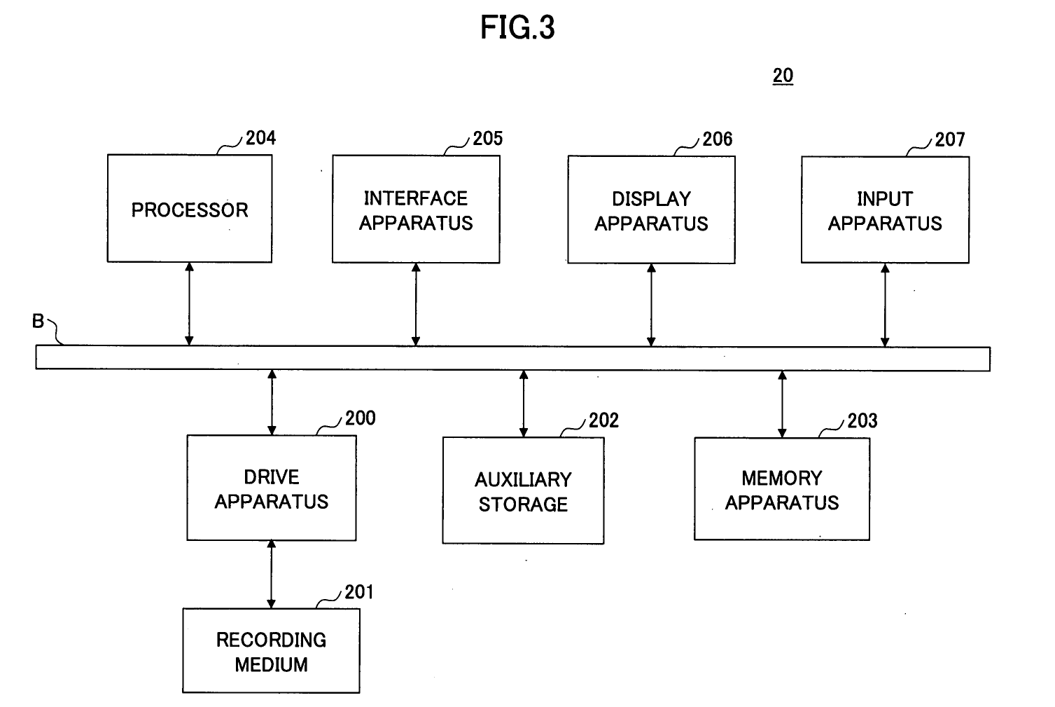

FIG. 3 is a diagram showing a configuration example of hardware of a client computer according to the embodiment of the present invention. The client computer 20 in FIG. 3 comprises a drive apparatus 200, an auxiliary storage 202, a memory apparatus 203, a processor 204, an interface apparatus 205, a display apparatus 206, an input apparatus 207, and the like in which all the elements are connected to one another via a bus B.

The client program 21 for performing processing in the client computer 20 is provided by a recording medium 201 such as a CD-ROM. When the recording medium 201 in which the client program 21 is recorded is set in the drive apparatus 200, the client program 21 is installed in the auxiliary storage 202 from the recording medium 201 via the drive apparatus 200.

The auxiliary storage 202 stores necessary files, data, and the like in addition to the installed client program 21. For example, the auxiliary storage 202 stores various tables below which are necessary to process the client program 21.

The memory apparatus 203 reads the client program 21 from the auxiliary storage 202 upon instruction to activate the client program 21. The processor 204 performs the functions of the client computer 20 in accordance with the client program 21 stored in the memory apparatus 203. The interface apparatus 205 is used as an interface to connect to a network 30 in FIG. 1.

The display apparatus 206 displays GUI and the like used by the client program 21. The input apparatus 207 comprises a keyboard, a mouse, and the like, and is used to input various operation instructions.

The server computer 10 also comprises hardware in the same manner as in FIG. 3. However, the display apparatus 206 and the input apparatus 207 are not necessarily required.

In the following, the processing procedure of the document information managing system 1 in FIG. 1 is described. In order for a user to use the document information managing system 1, it is necessary to activate the client program in the client computer 20. The activation of the client program 21 is performed by clicking on an icon of the client program 21, selecting the program in a menu, or the like.

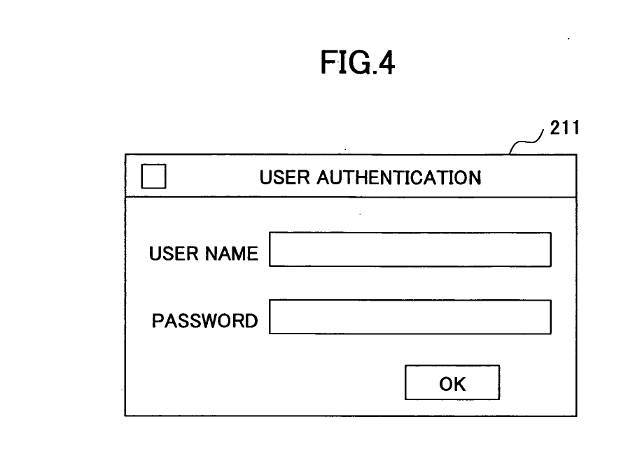

When the activation instruction is made, the processing portion 210 for inputting user information of the client program 21 displays a dialog for allowing the user to input user information (hereafter referred to as a user information input dialog) on the display apparatus 206. FIG. 4 is a diagram showing a display example of the user information input dialog.

When the user inputs a user name and a password in the user information input dialog 211 in FIG. 4, the processing portion 210 for inputting user information transmits the inputted user information to the user authentication processing portion 110 of the server computer 10. The user authentication processing portion 110 performs a user authentication process by checking user information registered in the user management DB 12 in advance with the received user information, and then transmits the result of the authentication process to the processing portion 210 for inputting user information.

If the user authentication has succeeded, the client program 21 enters a steady state and the processing portion 240 for obtaining browsed document information monitors events. The inputted user information is stored in the memory by the processing portion 210 for inputting user information. If the user authentication has failed, the user information input dialog 211 may be displayed again, prompting the user to input user information, or the client program 21 may be ended.

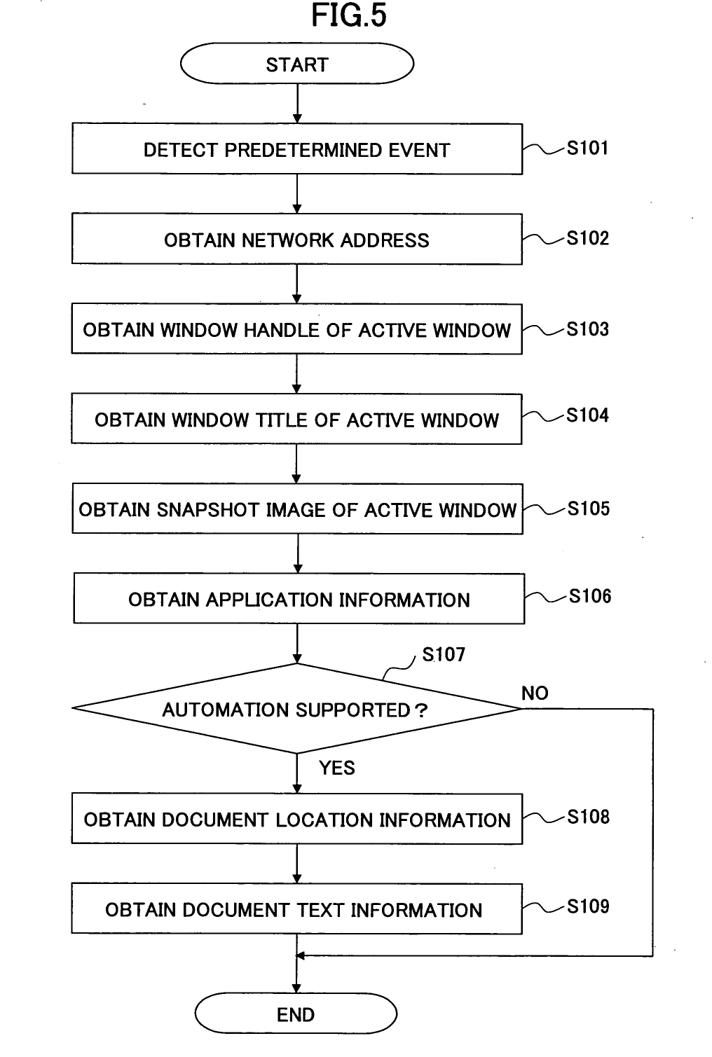

Next, a process for obtaining document information about a document being browsed is described. FIG. 5 is a flowchart describing a process for obtaining document information.

In the client computer 20, upon switching to an active window (application), for example, by activating a new application, switching to an application to be operated, or the like, the processing portion 240 for obtaining browsed document information detects an event thereof and starts the process for obtaining document information about a document being browsed (S101). In other words, in this case, the process in FIG. 5 is described on the assumption that the process is performed each time of switching to an active window. However, as will be described later, the process may be started in response to explicit instruction by the user.

In addition, in the window system of the computer, the state change of windows such as the activation of windows is performed by the OS sending a message to a window object. Thus, the processing portion 240 for obtaining browsed document information detects the switching of windows by monitoring messages sent by the OS to window objects (generally referred to as a message hook).

Following step S101, the process proceeds to step S102, where the processing portion 240 for obtaining browsed document information obtains the network address (IP address) of the client computer 20. However, the obtainment of the network address does not have to be performed at this time. The network address may be obtained before this step, such as in the user authentication using the client computer 20, for example.

Next, the processing portion 240 for obtaining browsed document information identifies an active window (S103). For example, in the Windows (registered trademark) environment, by using an API such as “GetActiveWindow( )” in Win32API, it is possible to obtain the handle of a currently active window.

Next, the processing portion 240 for obtaining browsed document information obtains the window title of the active window and the obtained window title is handled as a document title (S104). In this case, although an application name or the like can be used for the window title, the document title may include the application name. For example, in Windows (registered trademark), the window title can be obtained by using an API such as “GetWindowText( )” with the handle of the window as an argument.

Next, the processing portion 240 for obtaining browsed document information obtains a snapshot image of the active window (S105). In Windows (registered trademark), it is possible to store the snapshot image of the active window in a clipboard by pressing the “Alt” key and the “Print Screen” key. Thus, by sending key input information indicating that the “Alt” key and the “Print Screen” key are pressed to the active window, using an API such as “keybd_event( )”, it is possible to store the snapshot image of the active window in the clipboard. Thereafter, the processing portion 240 for obtaining browsed document information obtains the snapshot image from the clipboard.

Next, the processing portion 240 for obtaining browsed document information obtains application information about an application by which a document being browsed is displayed in the active window (S106). For example, in the Windows (registered trademark) environment, by using an API such as “GetWindowThreadProcessId( )”, it is possible to obtain, in accordance with the window handle, the path name and the execution file name of the application module by which the window is displayed. Thus, it is possible to identify the application by which the document being browsed is displayed (hereafter referred to as an active application).

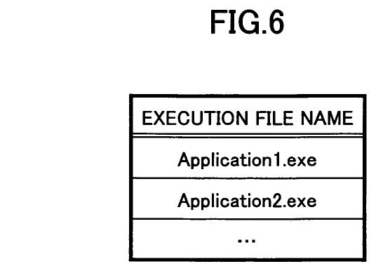

Next, the processing portion 240 for obtaining browsed document information determines whether or not the active application is capable of performing interprocess communications using a predetermined interface. In this case, the interprocess communications is described on the basis of OLE automation (hereafter referred to as automation) in the Windows (registered trademark) environment as an example. In order to determine whether a certain application supports the automation or not, for example, a list as shown in FIG. 6 may be created in advance.

FIG. 6 is a diagram showing an example of a list of applications supporting the automation. FIG. 6 shows a list of the execution file names of applications supporting the automation. By creating such a list in advance and confirming whether or not the execution file name obtained in step S106 is included in the list, it is possible to determine whether the active application supports the automation or not.

In the case where the active application supports the automation (YES in S107), the processing portion 240 for obtaining browsed document information obtains, in accordance with an interface the active application provides, document location information, text information included in a document, and the like (S108 and S109), and ends the process. On the other hand, in the case where the active application does not support the automation (NO in S107), the processing portion 240 for obtaining browsed document information ends the process without such information since the document location information, text information included in the document, and the like cannot be obtained from the active application.

Since various interfaces are supplied by each application through the automation, it is necessary to call the interfaces independently for each type of the applications in terms of implementation. Also, depending on the applications, text information and the like can be obtained by using the clipboard and the like without using the automation. However, if the interfaces are standardized in the future, it is possible to obtain text information and the like by the unified interface without considering the types of applications.

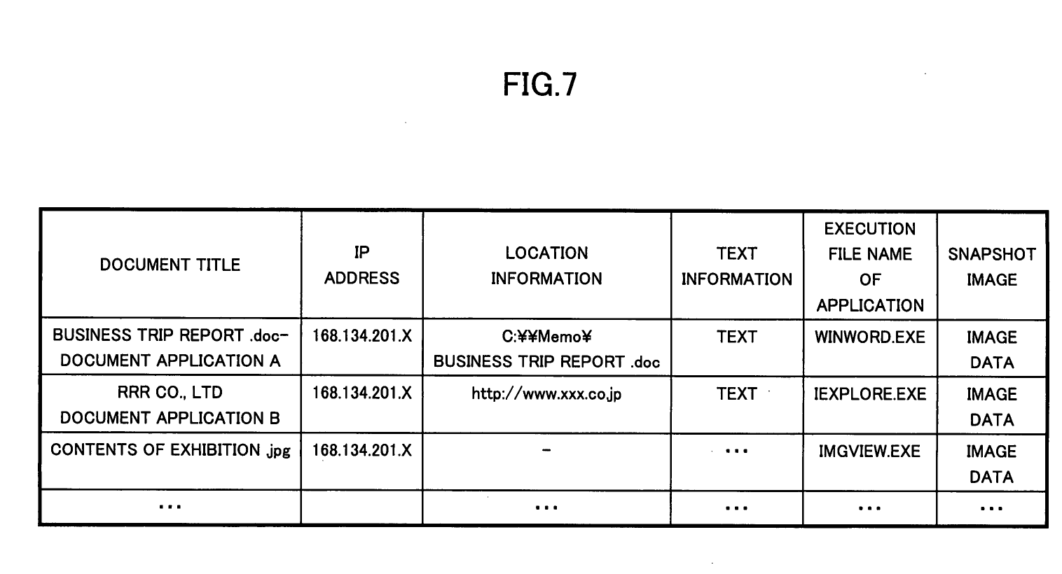

The information obtained in the process of FIG. 5 is stored in the memory or a file of the client computer 20 in a form as shown in FIG. 7. FIG. 7 is a diagram showing an example of document information obtained by the processing portion for obtaining browsed document information.

In FIG. 7, document information of each document includes a document title, an IP address, location information, text information, the execution file name of an application, a snapshot image, and the like. Regarding the text information and the snap shot image (binary data), actual data may be inserted in each item or location information such as a file path name or a pointer for the actual data may be inserted in each item. In FIG. 7, history of document information obtained in the past is included and displayed. However, in this case, only information about the document currently being browsed may be stored.

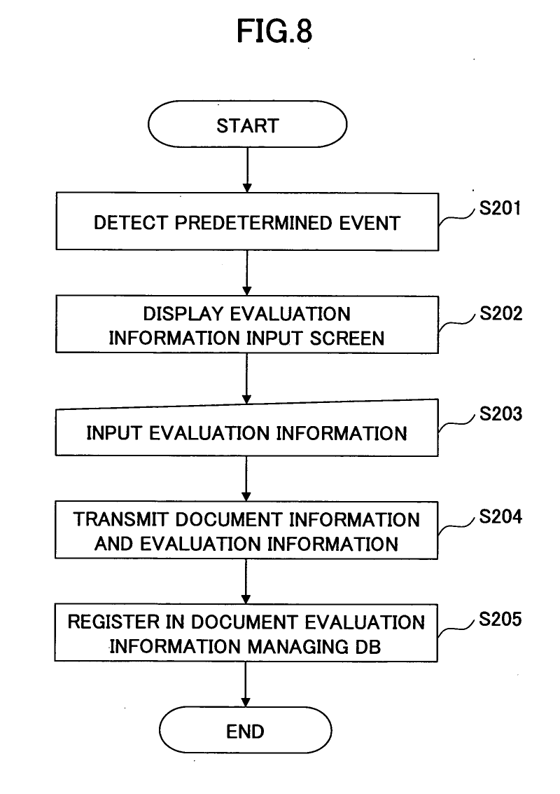

Next, a process for inputting evaluation information about the document being browsed is described. FIG. 8 is a flowchart describing the process for inputting evaluation information.

When the user browsing the document in the client computer 20 performs a predetermined operation, the processing portion 220 for inputting document evaluation information, monitoring an event generated on the basis of the operation, detects the event (S201) and starts the process for inputting evaluation information. The predetermined operation includes input from the input apparatus 207 such as a keyboard or a mouse, for example. In the present embodiment, the predetermined operation is performed by clicking the right button of the mouse while pressing the control key of the keyboard.

First, the processing portion 220 for inputting document evaluation information obtains document information in the active application obtained by the processing portion 240 for obtaining browsed document information and stored in the memory or a file. And the processing portion 220 for inputting document evaluation information displays a screen for allowing the user to input evaluation information (S202) (hereafter referred to as an evaluation information input screen).

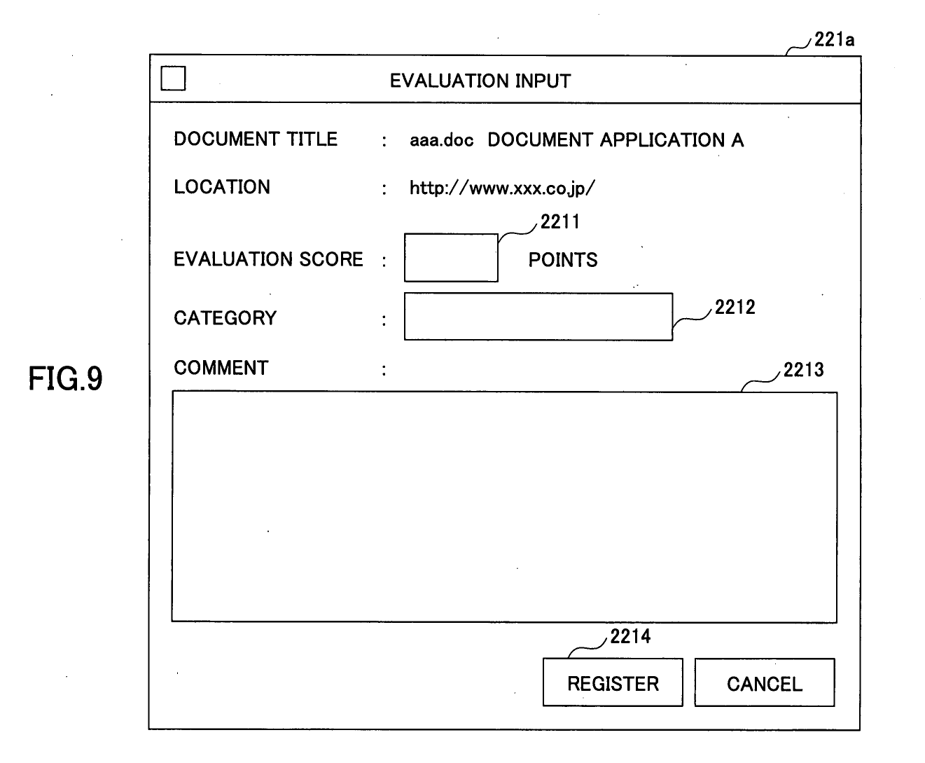

FIG. 9 is a diagram showing a first example of the evaluation information input screen. On an evaluation information input screen 221a, a document title and location information are displayed on the basis of the document information. An evaluation information input screen 221 has an evaluation score input area 2211, a category input area 2212, a comment input area 2213, and the like.

The evaluation score input area 2211 includes an area for allowing the user to input an evaluation score (a numerical value, for example) on the basis of a predetermined standard. The category input area 2212 includes an area for allowing the user to input a category of evaluation. The category of evaluation may be inputted as a character string or may be selected from a list of categories included in evaluation information already registered. The comment input area 2213 includes an area for allowing the user to input an arbitrary comment (a character string).

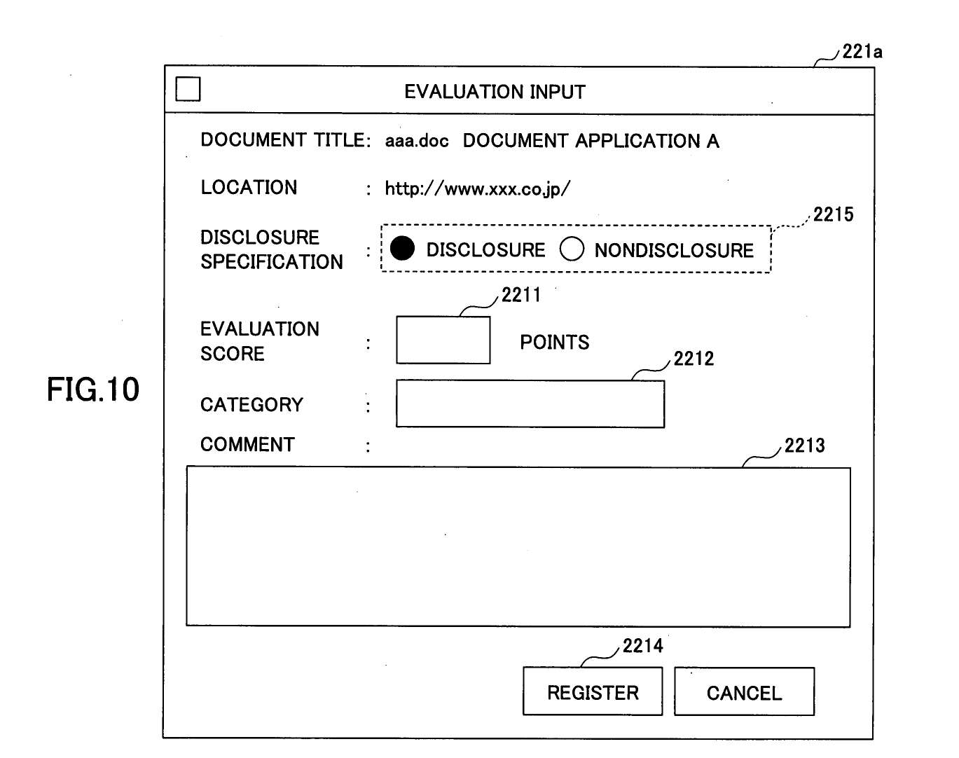

FIG. 10 is a diagram showing a second example of the evaluation information input screen. In FIG. 10, the same reference numerals as in FIG. 9 are assigned to the same portions and description thereof is omitted. An evaluation information input screen 221b in FIG. 10 has a disclosure specification area 2215 added thereto. The disclosure specification area 2215 includes an area for allowing the user to specify whether to permit other user to refer to the evaluation information (disclosure) or not (nondisclosure). In the example of FIG. 10, the disclosure specification area 2215 comprises radio buttons. In the following, when the evaluation information input screen 221a and the evaluation information input screen 221b are not particularly discriminated, they are described as an evaluation information input screen 221.

When evaluation information is inputted to the evaluation information input screen 221 (S203) and a registration button 2214 is clicked, the processing portion 220 for inputting document evaluation information transmits the document information and inputted evaluation information to the processing portion 120 for registering document evaluation information of the server computer 10 (S204).

The processing portion 120 for registering document evaluation information of the server computer 10 receives the document information and evaluation information, transmitted by the processing portion 220 for inputting document evaluation information, and registers the information in the document evaluation information managing DB 13 (S205).

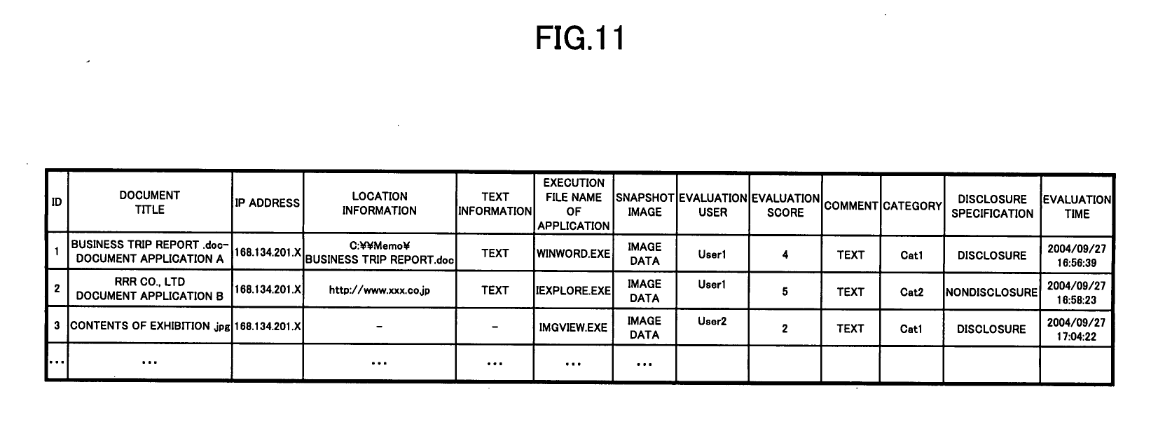

FIG. 11 is a diagram showing a configuration example of the document evaluation information managing DB. In FIG. 11, the document evaluation information managing DB 13 comprises items such as ID, document title, IP address (of the client computer 20), location information, text information, execution file name of an application, snapshot image, evaluation user, evaluation score, comment, category, disclosure specification, evaluation time, and the like.

Information included in the received document information is registered as the items of the document title, IP address, location information, text information, execution file name of an application, and snapshot image. Information included in the received evaluation information is registered as the items of the evaluation score, comment, category, and disclosure specification. Concerning the evaluation user, the processing portion 220 for inputting document evaluation information may be caused to transmit the user information stored in the client computer 20 along with the document information and evaluation information and the user information may be registered as the evaluation user, or the processing portion 120 for registering document evaluation information may determines the current user through a session with the client computer 20 and register the evaluation user on the basis of the determined result. Further, time of the registration in the document evaluation information managing DB 13 may be registered as the evaluation time by the processing portion 120 for registering document evaluation information.

The document information managing system 1 is capable of allowing the user of the client computer 20 to browse the document information and evaluation information registered by the process in FIG. 8. In the present embodiment, the processing portion 230 for displaying document evaluation information is described on the basis of a case where information is displayed using a Web browser, for example. However, it is not necessary to use the Web browser, the document information and evaluation information may be displayed through the implementation of a dedicated browser.

In the client computer 20, when the user inputs display conditions of evaluation information, the processing portion 230 for displaying document evaluation information transmits, along with the inputted display conditions, a request for displaying evaluation information to the processing portion 130 for generating display data of document evaluation information of the server computer 10.

The processing portion 130 for generating display data of document evaluation information searches the document evaluation information managing DB 13 for evaluation information on the basis of the received display request and generates a Web page in an HTML (HyperText Markup Language) form (hereinafter referred to as an evaluation information displaying page) based upon the retrieved evaluation information. The evaluation information displaying page is transmitted to the processing portion 230 for displaying document evaluation information via a Web server program (not shown in the drawings) in the server computer 10.

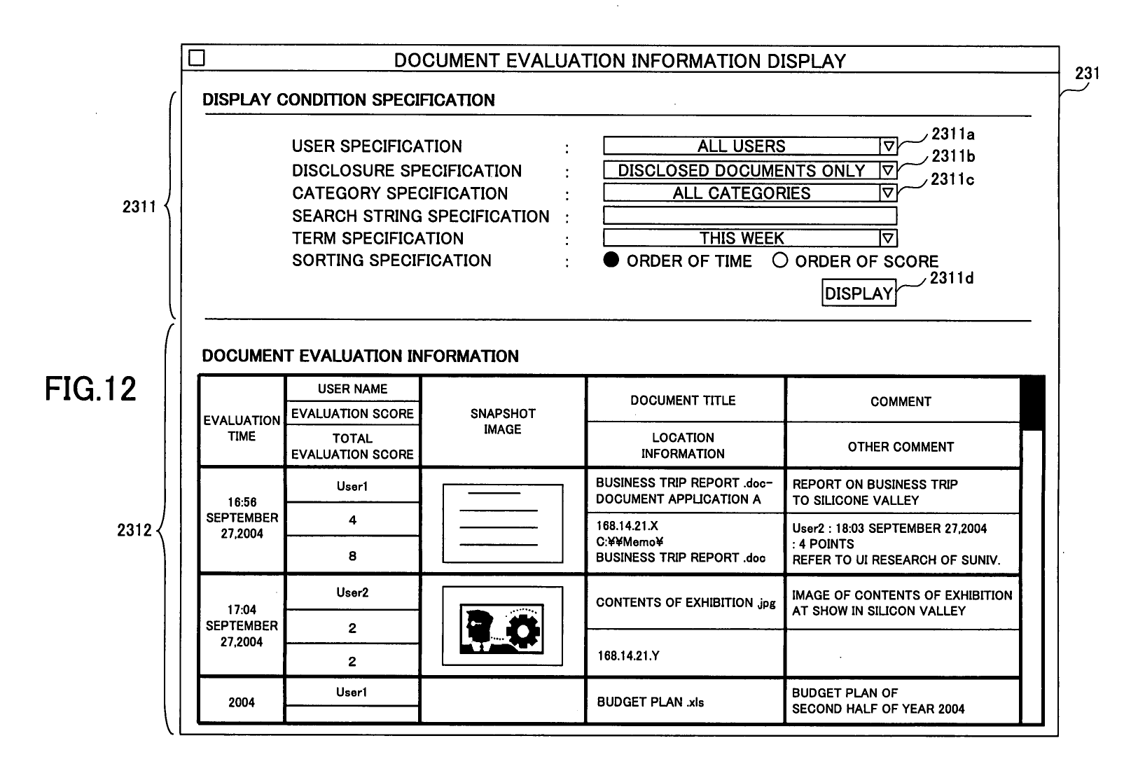

FIG. 12 is a diagram showing a display example of the evaluation information displaying page. An evaluation information displaying page 231 in FIG. 12 is an example of display in which the URL of the server computer 10 is specified in the Web browser of the client computer 20.

In a display condition input area 2311 of the evaluation information displaying page 231, it is possible to input the display conditions of evaluation information. The display conditions include user specification, disclosure specification, category specification, search string specification, term specification, sorting specification, and the like.

The user specification includes a condition for performing extraction on the basis of the evaluation user. In the example of the drawing, the user specification can be performed from a selectable list (2311a). It is possible to select, from the list, items of all the users registered in the document evaluation information managing DB 13 and an item of “all users” added thereto.

The disclosure specification includes a condition for performing extraction on the basis of a disclosure condition. In the example of the drawing, the disclosure specification can be performed from a selectable list (2311b). It is possible to select items such as “all documents”, “disclosed documents only”, “undisclosed documents only”, and the like.

The category specification includes a condition for performing extraction on the basis of a category. In the example of the drawing, the category specification can be performed from a selectable list (2311c). It is possible to select, from the list, items of all the categories registered in the document evaluation information managing DB 13 and an item of “all categories” added thereto.

The search string specification includes a condition for performing what is called a free word searching for information about the “document title”, “document text”, and “comment” managed in the document evaluation information managing DB 13.

The term specification includes a condition for performing extraction on the basis of evaluation time. In the example of the drawing, the term specification can be performed from a selectable list. It is possible to select items such as “all documents”, “today”, “yesterday”, “this week”, “last week”, “this month”, “last month”, and the like. Other terms may be added to the list or a specific date may be specified.

The sorting specification includes specification of display order of the evaluation information. In the example of the drawing, it is possible to select either “order of time” or “order of score”.

When the display conditions are inputted in the evaluation information displaying page 231 and a display button 2311d is clicked, evaluation information is displayed in an evaluation information displaying area 2312 of the evaluation information displaying page 231. In practice, the processing portion 130 for generating display data of document evaluation information regenerates the evaluation information displaying page 231 such that the evaluation information is displayed and the evaluation information displaying page 231 is displayed on the Web browser again.

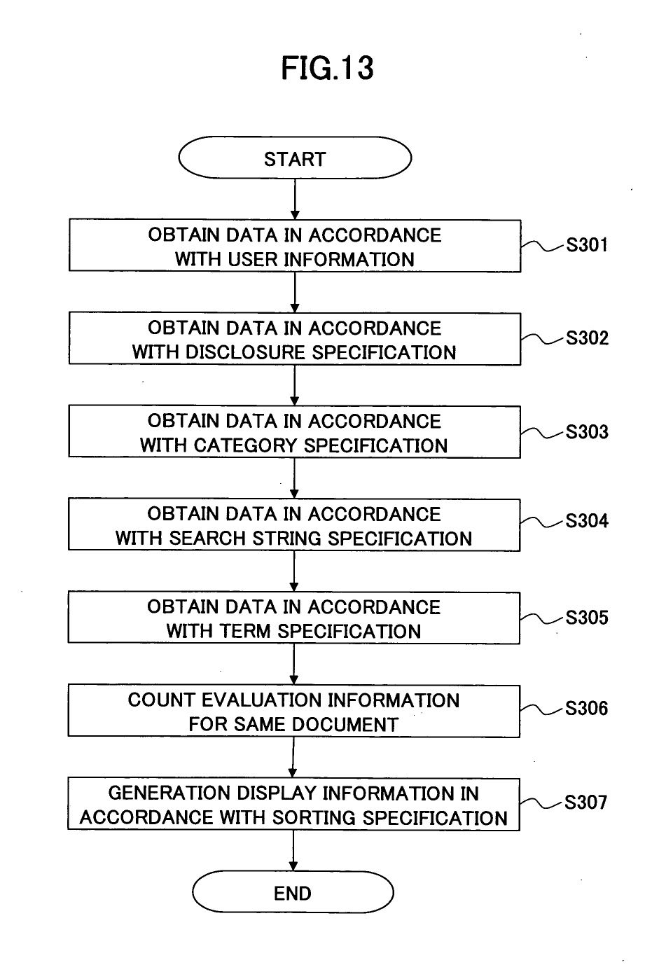

FIG. 13 is a flowchart describing a process for generating an evaluation information displaying page by the processing portion for generating display data of document evaluation information.

When the display request with the display conditions from the client computer 20 is received, the processing portion 130 for generating display data of document evaluation information performs the following process.

First, the processing portion 130 for generating display data of document evaluation information extracts evaluation information from the document evaluation information managing DB 13 in accordance with the condition specified in the “user specification” of the display conditions (S301).

Next, the processing portion 130 for generating display data of document evaluation information extracts evaluation information from the extracted evaluation information in accordance with the condition specified in the “disclosure specification” of the display conditions (S302). For example, in the case where a nondisclosure status is specified, only evaluation information such that the operating user inputted as the evaluation user is extracted. In other words, regarding evaluation information specified as undisclosed, information evaluated by the operating user can be extracted for browsing and other users cannot browse the information.

Next, the processing portion 130 for generating display data of document evaluation information extracts evaluation information from the extracted information in accordance with the condition specified in the “category specification” of the display conditions (S303).

Next, the processing portion 130 for generating display data of document evaluation information extracts evaluation information from the extracted information in accordance with the condition specified in the “search string specification” of the display conditions (S304).

Next, the processing portion 130 for generating display data of document evaluation information extracts evaluation information from the extracted information in accordance with the condition specified in the “term specification” of the display conditions (S305).

Next, the processing portion 130 for generating display data of document evaluation information performs a process for merging evaluation information concerning the same document using the extracted evaluation information (S306). The process for merging evaluation information corresponds to the calculation of the total score of evaluation scores for the same document, the merging of comments, and the like. The determination of the same document may be performed on the basis of the identity of location information of each document, for example.

Next, the processing portion 130 for generating display data of document evaluation information sorts the extracted evaluation information on the basis of the “sorting specification” of the display conditions and generates the evaluation information displaying page 231. In the example of FIG. 12, display information includes “evaluation time”, “user name”, “evaluation score”, “total evaluation score”, “snapshot image”, “document title”, “location information”, “comment”, “other comment”, and the like. The “snapshot image” may be displayed as a thumbnail image of a snapshot image and the original size image may be displayed on another page when the user clicks on the thumbnail image. In a case where the “location information” is displayed in a URL form, location information may be displayed as a link and information relating to the URL may be displayed on another page when the user clicks on the link. The “other comment” is displayed as a comment of other evaluation information made for the same document. When the other comment is displayed, preferably, the user name, the evaluation time, and the evaluation score are displayed together in addition to the comment.

As mentioned above, according to the document information managing system 1 of the present embodiment, the user is capable of collecting and managing document information about a document being browsed with a given application. In particular, the processing portion 240 for obtaining browsed document information automatically obtains document information in response to switching to an active window, so that the user is capable of omitting the need of inputting the document information by a manual operation.

Further, evaluation information about the collected document information can be readily inputted and registered. Thus, by sharing the registered evaluation information, it is possible to support the utilization of useful information from a large amount of information in an efficient manner.

Moreover, a disclosure range (disclosure or nondisclosure) can be specified for the evaluation information, so that it is possible to provide both functions of personal information management and information sharing among a plurality of users.

The present embodiment describes the example of allowing the user to input evaluation information. However, information to be inputted in association with document information may not necessarily be evaluation information. It may be changed, as required, depending on operation. For example, only a comment may simply be inputted.

Also, only document information, obtained by the processing portion 240 for obtaining browsed document information, may be managed without allowing the user to input evaluation information and the like. In this case, based upon the understanding that important documents tend to have longer browsing time and are likely to be printed, it is preferable to obtain and manage the browsing time of documents, information about the existence of printing operations, and the like including document information, since the importance of the documents can be determined on the basis of the length of the browsing time, the existence of printing operations, and the like.

The above describes the example (step S101 in FIG. 5) where the obtainment of document information is started in response to an event of switching to an active window. However, the process for obtaining the document information may be started upon explicit instruction (input from a mouse or a keyboard) by the user. For example, the process may be started by clicking the right button of the mouse while pressing the control key of the keyboard. In this case, the process for inputting evaluation information (FIG. 8) may be performed continuously from the process for obtaining the document information (namely, without detecting the event in step S201).

The present invention is not limited to the specifically disclosed embodiment, and variations and modifications may be made without departing from the scope of the present invention.

The present application is based on Japanese priority applications No. 2005-044529 filed Feb. 21, 2005 and No. 2005-269159 filed Sep. 15, 2005, the entire contents of which are hereby incorporated herein by reference.

What is claimed is:

1. An information processing apparatus capable of performing an application for allowing a user to operate a document using GUI, the information processing apparatus comprising:
an information obtaining unit configured to detect a predetermined event concerning the GUI and to obtain document information about a document to be operated in an active application upon detecting the predetermined event.

2. The information processing apparatus according to claim 1, wherein the document information includes at least one selected from a group consisting of a title of a window of the active application, a snapshot image of the window, and an execution file name of the active application.

3. The information processing apparatus according to claim 1, wherein the document information includes at least one selected from a group consisting of location information about a document to be operated in the active application and information about contents of the document.

4. The information processing apparatus according to claim 1, wherein the information obtaining unit obtains at least a portion of the document information through interprocess communications with the application.

5. The information processing apparatus according to claim 1, including an information registering unit configured to register the document information obtained by the information obtaining unit in a predetermined memory unit.

6. The information processing apparatus according to claim 5, including:
an information inputting unit configured to allow the user to input document-related information to be related to a document to be operated in the active application, wherein
the information registering unit registers the document information obtained by the information obtaining unit in association with the document-related information inputted by the user through the allowance of the information inputting unit.

7. The information processing apparatus according to claim 6, wherein the document-related information includes evaluation information about a document to be operated in the active application.

8. The information processing apparatus according to claim 6, wherein the information inputting unit allows the user to specify a disclosure status or a nondisclosure status of the document-related information to other user along with the input of the document-related information.

9. The information processing apparatus according to claim 8, including:
a display unit configured to display information on a display apparatus, the information being registered in the predetermined memory unit by the information registering unit, wherein
the display unit displays, concerning information inputted by other user, only information permitted to be disclosed.

10. The information processing apparatus according to claim 9, wherein the display unit displays merged information relating to the same document.

11. An information managing apparatus comprising:
a receiving unit configured to receive the document information and the document-related information from the information processing apparatus according to claim 6; and
a memory unit configured to store the document information and the document-related information received by the receiving unit.

12. The information managing apparatus according to claim 11, wherein
the receiving unit receives information indicating a disclosure status or a nondisclosure status of the document-related information to other user, and
the memory unit stores the document-related information in association with the information indicating the disclosure status or the nondisclosure status.

13. The information managing apparatus according to claim 12, including:
a display data generating unit configured to generate display data for displaying, in response to a request for displaying the document-related information, the document information and the document-related information stored in the memory unit, wherein
the display data generating unit generates, concerning the document-related information inputted by a user other than a user relating to the display request, the display data such that only information permitted to be disclosed is displayed.

14. An information processing method using a computer capable of performing an application for allowing a user to operate a document using GUI, the information processing method comprising the steps of:
event detecting for detecting a predetermined event concerning the GUI; and
information obtaining for obtaining document information about a document to be operated in an active application upon detecting the predetermined event in the event detecting step.

15. The information processing method according to claim 14, wherein the information obtaining step obtains at least a portion of the document information through interprocess communications with the application.

16. The information processing method according to claim 14, including the step of:
information registering for registering the document information obtained in the information obtaining step in a predetermined memory unit.

17. The information processing method according to claim 16, wherein the information registering step registers the document information obtained in the information obtaining step in the predetermined memory unit by transmitting the document information via a network.

18. The information processing method according to claim 16, including the step of:
information inputting for allowing the user to input document-related information to be related to a document to be operated in the active application, wherein
the information registering step registers the document information obtained in the information obtaining step in association with the document-related information inputted in the information inputting step.

19. The information processing method according to claim 18, wherein the information inputting step allows the user to specify a disclosure status or a nondisclosure status of the document-related information to other user along with the input of the document-related information.

20. An information processing program for causing a computer, capable of performing an application for allowing a user to operate a document using GUI, to perform the steps of:
event detecting for detecting a predetermined event concerning the GUI; and
information obtaining for obtaining document information about a document to be operated in an active application upon detecting the predetermined event in the event detecting step.
